(19) United States
(12) Patent Application Publication
(10) Pub. No.: US 2024/0208182 A1
(43) Pub. Date: Jun. 27, 2024

(54) LIQUID CRYSTAL POLYMER PELLET, LIQUID CRYSTAL POLYMER POWDER, LIQUID CRYSTAL POLYMER FILM, AND METHOD OF PRODUCING SAME

(71) Applicant: Murata Manufacturing Co., Ltd., Nagaokakyo-shi (JP)

(72) Inventors: Tatsuya YAMADA, Nagaokakyo-shi (JP); Narimichi MAKINO, Nagaokakyo-shi (JP); Yuta NAKANISHI, Nagaokakyo-shi (JP); Yuya IDA, Nagaokakyo-shi (JP)

(21) Appl. No.: 18/601,370

(22) Filed: Mar. 11, 2024

Related U.S. Application Data
(63) Continuation of application No. PCT/JP23/18960, filed on May 22, 2023.

(30) Foreign Application Priority Data
May 27, 2022 (JP) 2022-087057

(51) Int. Cl. B32B 15/14; B29C 48/00; B29C 48/05; B29C 48/87; B29L 7/00; B32B 15/20; B32B 38/00

(52) U.S. Cl. CPC B32B 15/14; B29C 48/0011; B29C 48/0022; B29C 48/05; B29C 48/87; B32B 15/20; B32B 38/0004; B32B 38/0036; B29K 2995/005; B29K 2995/0063; B29L 2007/00; B32B 2305/55; B32B 2307/514; B32B 2307/72; B32B 2311/12

(57) ABSTRACT

To obtain a liquid crystal polymer film having a small in-plane linear expansion coefficient. A liquid crystal polymer pellet contains a liquid crystal polymer and is used as a material of a liquid crystal polymer film. The liquid crystal polymer pellet has an orientation degree of 86% or more as measured by wide-angle X-ray scattering.

### CROSS REFERENCE TO RELATED APPLICATIONS

The present application is a continuation n of International application No. PCT/JP2023/018960, filed May 22, 2023, which claims priority to Japanese Patent Application No. 2022-087057, filed May 27, 2022, the entire contents of each of which are incorporated herein by reference.

### TECHNICAL FIELD

The present invention relates to a liquid crystal polymer pellet, a method of producing a liquid crystal polymer pellet, a liquid crystal polymer powder, a method of producing a liquid crystal polymer powder, a liquid crystal polymer film, and a method of producing a liquid crystal polymer film.

### BACKGROUND ART

In recent years, as a new substrate material for printed wiring corresponding to next-generation high-speed transmission, a liquid crystal polymer (LCP), which is a material having a smaller transmission loss than the conventional material and excellent high-frequency characteristics, has attracted attention. LCP has excellent low dielectric constant characteristics, high heat resistance, and low water absorbability as compared with a polyimide resin which is a conventional substrate material, and thus can reduce loss of an electric signal or the like.

As a method of preparing an LCP film used for a printed wiring board or the like from a liquid crystal polymer, for example, a melt extrusion method and a solution casting method are known. The melt extrusion method is a method of forming a film by extruding a molten resin from an apparatus and bringing the resin into contact with a roll. The solution casting method is a method in which a varnish obtained by dissolving an LCP raw material such as an LCP pellet in a solvent is applied onto a flat belt and dried to form an LCP film.

Meanwhile, Patent Document 1 describes a method of producing a fibrillar liquid crystal polymer powder. In this method, first, a biaxially oriented film of a liquid crystal polymer is ground to obtain a liquid crystal polymer (LCP) powder. Next, the obtained LCP powder is treated using a wet high-pressure crushing device to produce a fibrillated LCP powder. An LCP film can also be produced using such a fibrillar LCP powder as a raw material.

As a method of producing a pellet of a thermoplastic resin, the most commonly used method is a method (cold cut method) in which a molten polymer passed through a spinneret provided at a discharge outlet is extruded into a string shape, and cooled and solidified by passing through a water bath, and the obtained string shape material is cut into pellets (see, for example, Patent Document 2 (Japanese Patent Application Laid-Open No. 10-180753)).
Patent Document 1: Japanese Patent No. 5904307
Patent Document 2: Japanese Patent Application Laid-Open No. 10-180753

### SUMMARY OF THE INVENTION

When the liquid crystal polymer film is used for, for example, a printed wiring board or the like, it is desirable that the liquid crystal polymer film has high surface smoothness (flatness) and high dimensional stability (small in-plane linear expansion coefficient) in order to enhance reliability or the like of the printed wiring. Here, the conventional liquid crystal polymer film has room for further improvement in reduction of the in-plane linear expansion coefficient.

In view of the above problems, an object of the present invention is to obtain a liquid crystal polymer film having a small in-plane linear expansion coefficient.

A liquid crystal polymer pellet according to the first aspect of the present invention contains a liquid crystal polymer having an orientation degree of 86% or more as measured by wide-angle X-ray scattering.

A method of producing a liquid crystal polymer powder according to a second aspect of the present invention includes: grinding the liquid crystal polymer pellet in a state of being dispersed in liquid nitrogen to obtain a granular finely ground liquid crystal polymer; and crushing the finely ground liquid crystal polymer by a wet high-pressure crushing device to obtain a liquid crystal polymer powder.

A liquid crystal polymer film according to a third aspect of the present invention includes a liquid crystal polymer. An in-plane linear expansion coefficient of the liquid crystal polymer film is 20 ppm/° C. or less.

According to the present invention, the in-plane linear expansion coefficient of the liquid crystal polymer film can be reduced.

### BRIEF EXPLANATION OF THE DRAWINGS

FIG. 1 is a view showing a relationship between an orientation degree of a liquid crystal polymer pellet and a linear expansion coefficient (CTE) of a liquid crystal polymer film in Examples and Comparative Examples.

FIG. 2 is a view showing a relationship between the orientation degree and a solidified bulk density of the liquid crystal polymer pellet in Examples and Comparative Examples.

FIG. 3 is a photograph of a liquid crystal polymer pellet in Example 1.

FIG. 4 is a photograph of a liquid crystal polymer pellet in Comparative Example 1.

FIG. 5 is a photograph of a liquid crystal polymer pellet in Comparative Example 2.

FIG. 6 is a photograph of the liquid crystal polymer pellet in Example 2.

FIG. 7 is a photograph of the liquid crystal polymer pellet in Example 3.

FIG. 8 is a photograph of the liquid crystal polymer pellet in Example 4.

FIG. 9 is a flowchart showing a process for producing the liquid crystal polymer pellet of an embodiment.

FIG. 10 is a flowchart showing a process for producing the liquid crystal polymer powder of the embodiment.

FIG. 11 is a flowchart showing a process for producing the liquid crystal polymer film of the embodiment.

FIG. 12 is a graph showing a relationship between a take-up speed in Reference Test 1 and each of the solidified bulk density of the LCP pellet, the orientation degree of the LCP pellet, and the CTE of the LCP film.

FIG. 13 is a graph showing a relationship between a melting temperature in Reference Test 2 and each of the solidified bulk density of the LCP pellet, the orientation degree of the LCP pellet, and the CTE of the LCP film.

FIG. 14 is a flowchart showing a step for producing a fiber mat of the embodiment.

FIG. 15 is a view showing a matting step of matting a liquid crystal polymer powder in the step for producing a fiber mat.

FIG. 16 is a view showing a step of irradiating a second surface of the fiber mat with light.

### DETAILED DESCRIPTION OF THE PREFERRED EMBODIMENTS

Hereinafter, the embodiments of the present invention will be described, but the present invention is not limited thereto.

### <Liquid Crystal Polymer Pellet>

A liquid crystal polymer (LCP) pellet according the present embodiment contains a liquid crystal polymer and is used as a material of a liquid crystal polymer film. The liquid crystal polymer has an orientation degree of 86% or more as measured by wide-angle X-ray scattering (WAXS).

Wide-angle X-ray scattering (WAXS) analysis is a measurement method of observing scattered X-rays generated when a sample is irradiated with X-rays, and can calculate a crystal structure of a polymer and an orientation degree (a ratio at which directions of molecular chains are aligned) of the polymer.

In the present embodiment, the WAXS analysis is performed using a wide-angle measurement mode of a small-angle X-ray scattering analyzer (“NANOPIX” manufactured by Rigaku Corporation). A distance between the sample and a detector is set to 80 mm, and Si is used for calibration of the distance. The sample is irradiated with X-rays and the scattered X-rays are detected by the detector in a vacuum environment. Between the sample and the detector, a beam stopper is placed, which blocks some of the scattered X-rays from reaching the detector. A cut-cross section of the pellet is irradiated with the X-ray at 80° to 100°. The degree of orientation is calculated from an annular integration at the strongest peak of scattering intensity of the scattered X-rays.

A solidified bulk density of the liquid crystal polymer pellet is preferably less than 0.3 g/cm³, more preferably 0.09 to 0.35 g/cm³. In this case, the liquid crystal polymer pellet can be easily ground.

In the measurement of the solidified bulk density, first, the LCP pellet is filled up to a scale of 100 mL in a measuring cylinder (maximum scale: 100 mL), and the weight of the filled LCP pellet is measured. Thereafter, tapping (vertical vibration of the measuring cylinder) is performed 10 times, and a volume of the LCP pellet after tapping is confirmed on the scale of the measuring cylinder. The solidified bulk density is calculated from the following formula.

Solidified bulk density (g/cm³)=[weight (g) of filled LCP pellet]/[volume (cm³) of LCP pellet after tapping]

The liquid crystal polymer pellet preferably has a fibrous branch portion such as burrs and fluffs. When the liquid crystal polymer pellet has the fibrous branch portion, the liquid crystal polymer pellet can be ground in a short time by low-temperature grinding.

The liquid crystal polymer is, for example, a thermotropic liquid crystal polymer. A molecule of the liquid crystal polymer has a negative linear expansion coefficient (thermal expansion coefficient: CTE) in an axial direction of a molecular axis and a positive CTE in a radial direction of the molecular axis. The liquid crystal polymer preferably has no amide bond.

Examples of the thermotropic liquid crystal polymer having no amide bond include a copolymer of parahydroxybenzoic acid, terephthalic acid, and dihydroxybiphenyl (a block copolymer of parahydroxybenzoic acid and ethylene terephthalate) having a high melting point and a low CTE, which is called a type-1 liquid crystal polymer, and a copolymer of parahydroxybenzoic acid and 2,6-hydroxynaphthoic acid (a block copolymer) having a melting point between a type-1 liquid crystal polymer and a type-2 liquid crystal polymer, which is called type-1.5 (or type-3).

The melting point of the liquid crystal polymer is preferably higher than 280° C., and more preferably 300° C. or higher. The “melting point” as used herein means an “endothermic peak temperature” as measured when the LCP is heated to 400° C. under an inert atmosphere, then cooled to normal temperature at a temperature decreasing rate of 40° C./min or more, and heated again at a temperature increasing rate of 40° C./min while an endothermic peak temperature measured using a differential scanning calorimeter. When the melting point (endothermic peak temperature) of the LCP exceeds 300° C., an LCP film excellent in heat resistance can be obtained.

From the viewpoint of molding the LCP film, the melting point of the liquid crystal polymer is preferably lower than the decomposition temperature of the LCP, and is preferably, for example, 400° C. or lower.

The melt viscosity of the liquid crystal polymer is preferably 15 to 79 Pa·s. This can further improve the in-plane CTE of the LCP film.

The melt viscosity of the liquid crystal polymer is measured by a capilograph manufactured by Toyo Seiki Seisaku-sho, Ltd. in accordance with JIS K 7199 under the following measurement conditions.

Temperature: (Melting point+25° C.)

Shear rate: 1000 Sec⁻¹

Capillary: Length: 20 mm/diameter: 1 mm

### <Method of Producing Liquid Crystal Polymer Pellet>

Hereinafter, a method of producing a liquid crystal polymer pellet according to an embodiment of the present invention will be described.

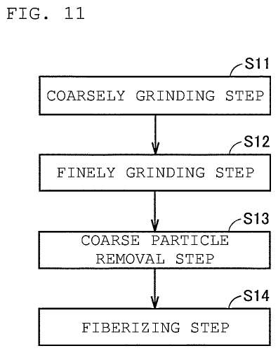

As shown in FIG. 9, the method of producing a liquid crystal polymer pellet according to the present embodiment includes a melt-kneading step (S01), an extrusion step (S02), a cooling step (S03), and a cutting step (S04) in this order.

### (Melt-Kneading Step: S01)

In the melt-kneading step, a liquid crystal polymer raw material is kneaded while being heated and melted.

The melt-kneading step can be performed using, for example, a co-rotating twin screw extruder. Kneading is performed, for example, by means of a screw (such as a co-rotating twin screw extruder). The heating temperature (melting temperature) is preferably about the same as or higher than the melting point of the LCP raw material. When the melting temperature is lower than the melting point of the LCP raw material, the degree of orientation of the LCP pellet tends to decrease.

### (Extrusion Step: S02)

In the extrusion step, the liquid crystal polymer raw material after the melt-kneading step is extruded into a string shape. Specifically, for example, the liquid crystal polymer raw material is extruded in a nozzle direction while being kneaded by the rotation of the screw, and the string shape liquid crystal polymer (string shape material) is extruded from a hole of the nozzle.

### (Cooling Step: S03)

In the cooling step, the string shape material obtained in the extrusion step is cooled in water while being taken up.

Here, a ratio [V/Q] of a take-up speed V (m/min) of the string shape material in the cooling step to an extrusion amount Q (kg/h) of the string shape material in the extrusion step is 5 to 20. When the ratio (draw ratio) [V/Q] is 5 or more, an LCP pellet having an orientation degree of 86% or more can be obtained. In a case where V/Q exceeds 20, there is a possibility that the string shape material is cut by taking up the string shape material, and it is considered that manufacturing may be difficult.

The extrusion amount (the same amount as the supply amount of the LCP raw material) is preferably 2 to 20 kg/h, and more preferably 2 to 10 kg/h. The take-up speed of the string shape material in the cooling step is preferably 4 to 70 m/min. The take-up speed is more preferably 20 to 60 m/min.

### (Cutting Step: S04)

In the cutting step, the string shape material after the cooling step is cut.

The liquid crystal polymer pellet of the present embodiment can be obtained by the above steps.

### <Liquid Crystal Polymer Powder>

A liquid crystal polymer (LCP) powder according to an embodiment of the present invention contains fibrous particles including a liquid crystal polymer.

### (Fibrous Particles)

The fibrous particles contained in the LCP powder are not particularly limited as long as they contain a fibrous portion. The fibrous portion may be linear or may have branching or the like.

An average aspect ratio of the fibrous particles is preferably 10 to 500, more preferably 300 or less, and still more preferably 100 or less. An average diameter of the fibrous particles is more preferably 2 μm or less, and more preferably 1 μm or less.

The LCP powder containing such fine fibrous particles cannot be produced by a conventionally known method. For example, ultrafine fibers including LCP after cutting continuous long fibers of LCP produced by a conventional electrospinning method usually have an aspect ratio of more than 500.

The average diameter and average aspect ratio of the fibrous particles contained in the LCP powder are measured by the following method.

### (Measurement of Average Diameter and Average Aspect Ratio of Fibrous Particles)

The LCP powder to be measured is dispersed in ethanol to prepare a slurry containing 0.01% by mass of the LCP powder. At this time, the slurry was prepared so that a moisture content in the slurry was 1% by mass or less. Then, 5 μL to 10 μL of this slurry was dropped onto a slide glass, and then the slurry on the slide glass was naturally dried. The LCP powder is disposed on the slide glass by naturally drying the slurry.

Next, a predetermined region of the LCP powder disposed on the slide glass is observed with a scanning electron microscope to collect 100 or more pieces of image data of the particles constituting the LCP powder. Note that, in the collection of the image data, the region was set according to the size per particle of the LCP so that the number of image data was 100 or more. Moreover, for each particle of the LCP, the image data was collected by appropriately changing a magnification of the scanning electron microscope to 500 times, 3,000 times, or 10,000 times in order to suppress leakage of the collection of the image data and occurrence of a measurement error.

Next, a longitudinal direction dimension and a width direction dimension of each particle of the LCP powder are measured using the collected image data.

A direction of a straight line connecting both ends of the longest path among paths that can be taken on one particle of the LCP powder photographed in each of the pieces of image data, that is, paths that pass from one end of the particle through substantially the center of the particle and reach an end opposite to the one end is defined as a longitudinal direction. Then, a length of a straight line connecting both ends of the longest path is measured as the longitudinal direction dimension.

Moreover, a particle dimension of one particle of the LCP powder in a direction orthogonal to the longitudinal direction was measured at three different points in the longitudinal direction. An average value of the dimensions measured at these three points was taken as the width direction dimension (fiber diameter) per particle of the LCP powder.

Furthermore, a ratio of the longitudinal direction dimension to the fiber diameter [longitudinal direction dimension/fiber diameter] is calculated and taken as the aspect ratio of the fibrous particles.

Then, the average value of the fiber diameters measured for 100 fibrous particles is taken as the average diameter.

Moreover, the average value of the aspect ratios measured for 100 fibrous particles is taken as the average aspect ratio.

Note that, the fibrous particles may be contained in the LCP powder as an aggregate in which the fibrous particles are aggregated.

Moreover, in the fibrous particles, the axial direction of the LCP molecules constituting the fibrous particles and the longitudinal direction of the fibrous particles tend to coincide with each other. Note that, it is considered that this is because, in a case where the LCP powder is produced through a fiberizing step described later, the axial direction of the LCP molecules is oriented along the longitudinal direction of the fibrous particles due to breakage between a plurality of domains formed by bundling the LCP molecules.

The bulk density of the LCP powder is preferably 2 to 5 mg/cm³.

In the LCP powder, a content (a number ratio) of particles other than the fibrous particles (massive particles that are not substantially fibrous) is preferably 20% or less. For example, when the LCP powder is placed on a plane, particles having a maximum height of 10 μm or less are fibrous particles, and particles having a maximum height of more than 10 μm are massive particles.

The LCP powder preferably has a D50 (an average particle size) value of 13 μm or less as measured by particle size measurement using a particle size distribution measuring device by a laser diffraction scattering method.

The liquid crystal polymer powder may further contain a zirconium compound. The zirconium compound is contained in an amount of preferably 0.001% by weight to 0.1% by weight, more preferably 0.003% by weight to 0.05% by weight with respect to the total amount of the liquid crystal polymer powder. Since the liquid crystal polymer powder contains a trace amount of the zirconium compound, the light irradiation efficiency can be increased by the light absorption characteristics of the zirconium compound when light is irradiated in the subsequent treatment step.

The zirconium compound refers to a compound containing a zirconium atom. Examples of the zirconium compound include zirconium acetate, zirconium hydroxide, and zirconium oxide, and among these, zirconium dioxide (zirconia) is preferably used. The zirconium compound contained in the liquid crystal polymer powder is preferably particulate, and the particle size is preferably 1 nm or more and 500 μm or less, and more preferably 10 nm or more and 100 nm or less. It is assumed that a zirconium compound used as a medium used at the time of grinding a coarsely ground liquid crystal polymer is mixed in the production process of the liquid crystal polymer powder.

### <Liquid Crystal Polymer Film>

The liquid crystal polymer (LCP) film according to an embodiment of the present invention includes a liquid crystal polymer.

The in-plane (XY direction) linear expansion coefficient (CTE) of the LCP film is preferably 20 ppm/° C. or less, and more preferably 18 to 20 ppm/° C.

The linear expansion coefficient of the LCP film is the in-plane (XY direction) linear expansion coefficient of the LCP film measured according to JIS K 7197 by a TMA (thermomechanical analysis) method. Conditions of the TMA method are as follows: a temperature is raised from room temperature to 150° C. at 10° C./min under a nitrogen atmosphere, a load is 10 g, and a sample shape is a strip shape (5 mm×15 mm).

As described above, the LCP film having an in-plane CTE of 20 ppm/° C. or less can be suitably used as a substrate for a flexible printed circuit (FPC), a diaphragm, an organic semiconductor substrate, an organic EL substrate, a damping plate, and the like as a circuit board. That is, the LCP film according to the present embodiment preferably has a small in-plane linear expansion coefficient from the viewpoint of being applicable to the above-described substrate and the like.

The thickness of the LCP film is preferably, for example, 5 μm or more and 250 μm or less.

The LCP film preferably has a water absorption rate of 0.2% by mass or less when immersed in water at normal temperature for 24 hours. As described above, when the water absorption rate is 0.2% by mass or less, the LCP film can be more suitably used as a circuit board member for high frequency. When the LCP film having a water absorption rate of 0.2% by mass or less is used as a circuit board member for high frequency, it is possible to suppress inclusion of water having an extremely high dielectric constant in a circuit board for high frequency, to suppress an increase in dielectric loss accompanying an increase in relative permittivity and dielectric loss tangent, and to suppress mismatch in characteristic impedance due to variation in dielectric constant and occurrence of transmission loss accompanying the mismatch. For example, an LCP film formed of a liquid crystal polymer in which an amine-derived structure is introduced into a molecular structure has a water absorption rate of more than 0.2% by mass because of relatively high water absorbency.

In the LCP film according to the present embodiment, a copper foil may be bonded to at least one surface, or copper foils may be bonded to both surfaces. In this case, the LCP film according to the present embodiment can be used as one laminated molded product, for example, as FCCL (Flexible Copper Clad Laminates) capable of forming a circuit by a subtract method.

### <Fiber Mat>

The fiber mat according to an embodiment of the present invention contains a liquid crystal polymer. A breaking tension of the fiber mat of the present embodiment is preferably 1.0 N/20 mm or more, and more preferably 1.2 N/20 mm or more. The breaking tension of the fiber mat may be 1.5 N/20 mm or more or 1.8 N/20 mm or more. According to the present invention, when heat treatment is performed at a temperature equal to or lower than the melting point of the liquid crystal polymer, the breaking tension can be improved as compared with the fiber mat before heat treatment, and a fiber mat having a breaking tension of 1.0 N/20 mm or more can be obtained.

The breaking tension of the fiber mat can be measured using an autograph (AG-XDplus manufactured by Shimadzu Corporation). In this case, the width of the fiber mat at the time of measurement is 20 mm.

The overall basis weight of the fiber mat is approximately 30 to 40 g/m². The overall density of the fiber mat is, for example, 0.30 to 0.60 g/m³, and the density increases as a fused region of the liquid crystal powder polymer in the thickness direction increases.

The thickness of the fiber mat is approximately 50 to 100 μm, and the thickness decreases as the fused region of the liquid crystal powder polymer in the thickness direction increases.

### <<Liquid Crystal Polymer Powder, Liquid Crystal Polymer Film, and Method of Producing Fiber Mat>>

Hereinafter, a liquid crystal polymer powder and a method of producing a liquid crystal polymer film according to an embodiment of the present invention will be described.

### <Method of Producing Liquid Crystal Polymer Powder>

As shown in FIG. 10, the method of producing a liquid crystal polymer powder according to the present embodiment includes a coarsely grinding step (S11), a finely grinding step (S12), a coarse particle removal step (S13), and a fiberizing step (S14) in this order.

### (Coarsely Grinding Step: S11)

In the coarsely grinding step, the LCP pellet is coarsely ground. For example, the LCP pellet is coarsely ground with a cutter mill. A size of the particles of the coarsely ground LCP is not particularly limited as long as the particles can be used as a raw material in the finely grinding step described later. A maximum particle size of the coarsely ground LCP is, for example, 3 mm or less.

The method of producing an LCP film according to the present embodiment may not necessarily include the coarsely grinding step. For example, if the LCP pellet can be used as a raw material in the finely grinding step, the LCP pellet may be directly used as a raw material in the finely grinding step. In the coarsely grinding step, it is preferable to perform coarsely grinding in a state of being dispersed under high pressure. The number of times of dispersion treatment is preferably 1 or more and 50 or less, and more preferably 1 or more and 10 or less. By performing grinding by high-pressure dispersion in the coarsely grinding step, a granular finely ground liquid crystal polymer is easily obtained in the subsequent step.

### (Finely Grinding Step: S12)

In the finely grinding step, the LCP pellet (after the coarsely grinding step) is ground in a state of being dispersed in liquid nitrogen to obtain a granular finely ground liquid crystal polymer (finely ground LCP).

In the finely grinding step, it is preferable that the LCP pellet which is dispersed in the liquid nitrogen is ground using a medium. The medium is, for example, a bead. As the medium, for example, particles of zirconia can be used. The particle size of zirconia used as the medium is preferably 0.1 mm or more and 10 mm or less, and more preferably 1 mm or more and 8 mm or less. In the finely grinding step of the present embodiment, it is preferable to use a bead mill having relatively few technical problems from a viewpoint of handling liquid nitrogen. Examples of the apparatus that can be used in the finely grinding step include “LNM-08” which is a liquid nitrogen bead mill manufactured by AIMEX CO., LTD.

In the finely grinding step of the present embodiment, a grinding method in which the liquid crystal polymer is ground in the state of being dispersed in liquid nitrogen is different from a conventional freeze grinding method. Although the conventional freeze grinding method is a method of grinding a ground raw material while pouring liquid nitrogen onto the ground raw material and a grinder main body, most of the liquid nitrogen is vaporized at the time when the ground raw material is ground. That is, in the conventional freeze grinding method, most of the ground raw material is not dispersed in the liquid nitrogen at the time when the ground raw material is ground.

In the conventional freeze grinding method, heat of the ground raw material itself, the heat generated from the grinder, and the heat generated by grinding the ground raw material vaporize liquid nitrogen in an extremely short time. Thus, in the conventional freeze grinding method, the raw material during grinding located inside the grinder has a temperature much higher than −196° C., which is the boiling point of liquid nitrogen. That is, in the conventional freeze grinding method, grinding is performed under the condition that an internal temperature of the grinder is usually about −100° C. or higher and 0° C. or lower. In the conventional freeze grinding method, when liquid nitrogen is supplied as much as possible, the temperature inside the grinder is approximately −150° C. at the lowest temperature.

For this reason, in the conventional freeze grinding method, for example, when a pelletized liquid crystal polymer (or coarsely ground product thereof) uniaxially oriented is ground, grinding proceeds along a plane substantially parallel to an axial direction of a molecular axis of the liquid crystal polymer, and therefore, it is considered that a fibrous liquid crystal polymer having a very large aspect ratio and a fiber diameter much larger than 3 μm is obtained. That is, by the conventional freeze grinding method, when the pelletized liquid crystal polymer uniaxially oriented is ground, a granular finely ground liquid crystal polymer as used in the present embodiment cannot be obtained.

In the present embodiment, since the ground raw material is ground in the state of being dispersed in liquid nitrogen, the raw material can be ground in a further cooled state as compared with the conventional freeze grinding method. Specifically, the ground raw material is ground at a temperature lower than −196° C., which is the boiling point of liquid nitrogen. When the ground raw material having a temperature lower than −196° C. is ground, brittle fracture of the ground raw material is repeated, so that the grinding of the raw material proceeds. As a result, for example, when a uniaxially oriented liquid crystal polymer is ground, not only the fracture progresses in the plane substantially parallel to the axial direction of the molecular axis of the liquid crystal polymer, but also the brittle fracture progresses along the plane intersecting the axial direction, so that the granular finely ground LCP can be obtained.

In the freeze grinding method of the present embodiment, the rotation speed of freeze grinding is preferably 1800 rpm or more, more preferably 2000 rpm or more, and still more preferably 2500 rpm or more. By adopting such a rotational speed, a granular finely ground liquid crystal polymer having a desired aspect ratio can be easily obtained.

In the finely grinding step in the present embodiment, the liquid crystal polymer formed into granules by brittle fracture in liquid nitrogen is continuously subjected to impact with a medium or the like in a brittle state. Thus, in the liquid crystal polymer obtained in the finely grinding step in the present embodiment, a plurality of fine cracks are formed from the outer surface to the inside.

The granular finely ground LCP obtained by the finely grinding step preferably has a D50 of 50 μm or less as measured by a particle size distribution measuring apparatus by a laser diffraction scattering method. This makes it possible to suppress clogging of the granular finely ground LCP with the nozzle in the following fiberizing step.

### (Coarse Particle Removal Step: S13)

Next, in the coarse particle removing step, coarse particles are removed from the granular finely ground LCP obtained in the finely grinding step. For example, the granular finely ground LCP is sieved with a mesh to obtain the granular finely ground LCP under the sieve, and the coarse particles contained in the granular finely ground LCP can be removed by removing the granular finely ground LCP on the sieve. A type of mesh may be appropriately selected, and examples of the mesh include a mesh having an opening of 53 μm. The method of producing a liquid crystal polymer powder according to the present embodiment may not necessarily include the coarse particle removal step.

### (Fiberizing Step: S14)

Next, in the fiberizing step, the granular finely ground LCP is crushed by a wet high-pressure crushing device to obtain a liquid crystal polymer powder. In the fiberizing step, first, the finely ground LCP is dispersed in a dispersing medium for the fiberizing step. In the finely ground LCP to be dispersed, the coarse particles may not be removed, but it is preferable that the coarse particles are removed. Examples of the dispersing medium for the fiberizing step include water, ethanol, methanol, isopropyl alcohol, toluene, benzene, xylene, phenol, acetone, methyl ethyl ketone, diethyl ether, dimethyl ether, hexane, and mixtures thereof.

Then, the finely ground LCP in a state of being dispersed in the dispersing medium for the fiberizing step, that is, the paste-like or slurry-like finely ground LCP is passed through the nozzle in a state of being pressurized at high pressure. By allowing the liquid crystal polymer to pass through the nozzle at a high pressure, a shearing force or collision energy due to high-speed flow in the nozzle acts on the liquid crystal polymer, and the granular finely ground LCP is crushed, so that the fiberization of the liquid crystal polymer proceeds, and the liquid crystal polymer powder that can be used in the method of producing a liquid crystal polymer film can be obtained. A nozzle diameter of the nozzle is preferably as small as possible within a range in which clogging of the finely ground LCP does not occur in the nozzle from a viewpoint of applying high shear force or high collision energy. Since the granular finely ground LCP in the present embodiment has a relatively small particle diameter, the nozzle diameter in the wet high-pressure crushing device used in the fiberizing step can be reduced. The nozzle diameter is, for example, 0.2 mm or less.

In the present embodiment, as described above, a plurality of fine cracks are formed in the granular finely ground LCP. Therefore, the dispersing medium enters into the finely ground LCP through fine cracks by pressurization in a wet high-pressure crushing device. Then, when the paste-like or slurry-like finely ground LCP passes through the nozzle and is positioned under normal pressure, the dispersing medium that has entered the finely ground LCP expands in a short time. When the dispersing medium that has entered the finely ground LCP expands, destruction progresses from inside of the finely ground LCP. Thus, fiberization proceeds to the inside of the finely ground LCP, and the molecules of the liquid crystal polymer are separated per domain arranged in one direction. As described above, in the fiberizing step according to the present embodiment, by defibrating the granular finely ground LCP obtained in the finely grinding step in the present embodiment, it is possible to obtain the liquid crystal polymer powder which has a low content of massive particles and is in the fine fibrous form as compared with the liquid crystal polymer powder obtained by crushing the granular liquid crystal polymer obtained by the conventional freeze grinding method.

In the fiberizing step in the present embodiment, the finely ground LCP may be crushed by a wet high-pressure crushing device to obtain the liquid crystal polymer powder. The number of times of crushing by the wet high-pressure crushing device is preferably small. The number of times of crushing by the wet high-pressure crushing device may be, for example, five times or less.

### <Method of Producing Liquid Crystal Polymer Film>

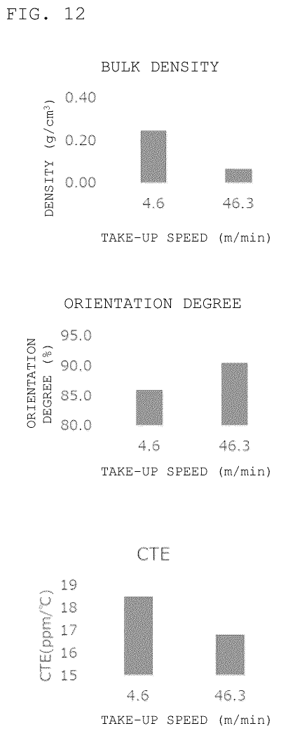

As shown in FIG. 11, the method of producing a liquid crystal polymer film according to the present embodiment includes a dispersion step (S21), a matting step (S22), a heat-pressing step (S23), and a metal foil removing step (S24).

### (Dispersion Step: S21)

In the dispersion step which is the first step of the method of producing a liquid crystal polymer film, the liquid crystal polymer powder is dispersed in a dispersing medium to form a paste or a slurry. As described above, in the present embodiment, since the liquid crystal polymer powder in the ultrafine fiber form is used, the liquid crystal polymer powder can be dispersed in a highly viscous dispersing medium. As a result, a homogeneous liquid crystal polymer film can be produced.

Examples of the dispersing medium used in the dispersion step include water, terpineol, ethanol, and mixtures thereof. For example, when terpineol is used as the dispersing medium, a paste-like liquid crystal polymer powder is obtained. When a mixture of ethanol and water is used as the dispersing medium, a slurry-like liquid crystal polymer is obtained.

### (Matting Step: S22)

Next, in the matting step, the paste-like or slurry-like liquid crystal polymer powder is dried to form a liquid crystal polymer fiber mat. In one embodiment of the present invention, the matting step includes, for example, an application step and a drying step.

In the application step, a paste-like liquid crystal polymer powder is applied to a metal foil such as a copper foil. In the application step, a paste-like liquid crystal polymer powder is applied onto a metal foil such as a copper foil as described above; however, a polyimide film, a PTFE (polytetrafluoroethylene) film, or a composite sheet including a reinforcing material such as a glass fiber fabric and a heat-resistant resin may be used instead of the metal foil. This makes it easy to industrially produce a liquid crystal polymer film.

Next, the paste-like liquid crystal polymer applied to the copper foil is heated and dried in the drying step to vaporize the dispersing medium. The dispersing medium may be vaporized by suction. By the above heating and drying, a liquid crystal polymer fiber mat is formed on a metal foil such as a copper foil.

In the drying step, since the dispersing medium is gradually removed from the paste-like liquid crystal polymer powder, the entire thickness of the paste-like liquid crystal polymer powder gradually decreases during drying. Thus, the thickness of the liquid crystal polymer fiber mat is thinner than the entire thickness of the paste-like liquid crystal polymer formed on the copper foil. Specifically, in the present embodiment, the entire thickness of the paste-like liquid crystal polymer powder is about 700 μm, and the thickness of the liquid crystal polymer fiber mat is, for example, about 150 μm.

Furthermore, as the total thickness of the paste-like LCP powder gradually decreases during drying, a longitudinal direction of the fibrous particles in the LCP powder changes. Specifically, among the fibrous particles, the fibrous particles having a longitudinal direction in a direction along the entire thickness direction of the paste-like liquid crystal polymer powder are inclined such that the longitudinal direction is directed in the in-plane direction of the copper foil. Therefore, there is anisotropy in the longitudinal direction of the fibrous particles in the formed liquid crystal polymer fiber mat.

In the matting step, a paste-like liquid crystal polymer may be further applied onto the liquid crystal polymer fiber mat formed on the metal foil in the drying step, and then the liquid crystal polymer may be dried to vaporize the dispersing medium. As described above, the matting step may include the application step and the drying step repeatedly in this order. Thus, a liquid crystal polymer fiber mat having a desired basis weight can be obtained.

The liquid crystal polymer fiber mat according to the present embodiment is formed such that the fibrous particles of the liquid crystal polymer powder are entangled with each other. The liquid crystal polymer fiber mat has a void between liquid crystal polymer powders. As described above, since the longitudinal direction of the fibrous particles in the liquid crystal polymer powder is inclined toward the in-plane direction of the copper foil as a whole, porosity of the liquid crystal polymer fiber mat tends to be larger than that of a liquid crystal polymer mat obtained by matting a conventional liquid crystal polymer powder containing no fibrous particles. The porosity is, for example, 80% to 90%.

In the matting step in the present embodiment, a paste-like or slurry-like liquid crystal polymer powder may be formed into a liquid crystal polymer fiber mat by a papermaking method instead of the application step and the drying step. According to the papermaking method, it is not necessary to use a special dispersing medium used in the application step, for example, expensive terpineol. In the papermaking method, the dispersing medium used in the dispersion step can be recovered and reused. As described above, the liquid crystal polymer film can be produced at low cost by the papermaking method.

In the matting step using the papermaking method, specifically, first, a paste-like or slurry-like liquid crystal polymer powder is paper-made on a mesh, a nonwoven fabric-like microporous sheet, or a woven fabric. Then, the paste-like or slurry-like liquid crystal polymer disposed on the mesh is heated and dried to obtain a liquid crystal polymer fiber mat.

### (Heat-Pressing Step: S23)

Next, in the heat-pressing step, the liquid crystal polymer fiber mat is heat-pressed to obtain a liquid crystal polymer film. Specifically, in the heat-pressing step, the liquid crystal polymer fiber mat is heat-pressed together with a copper foil. Thus, the heat-pressing step also serves as a step of bonding the liquid crystal polymer film and the copper foil to each other, so that a liquid crystal polymer film to which the copper foil is bonded can be obtained at low cost. In the case where the liquid crystal polymer fiber mat is heated for a long time in the heat-pressing step, it is preferable that the liquid crystal polymer fiber mat is heated and pressed in a vacuum. In the heat-pressing step, pre-pressing may be performed at a temperature of 220° C. or lower before vacuum heat-pressing is performed. By performing the pre-pressing, the density of the fiber mat can be increased, and the linear expansion coefficient (CTE) of the liquid crystal polymer film can be reduced. The density of the fiber mat is preferably 0.1 to 1.5 g/cm³ and more preferably 0.3 to 1.4 g/cm³.

In the heat-pressing step, it is preferable to perform heat-pressing at a temperature lower by about 5° C. to 15° C. than the melting point of the liquid crystal polymer (raw material) constituting the liquid crystal polymer powder. When heat-pressing is performed at a temperature lower by about 5° C. to 15° C. than the endothermic peak temperature, sintering of the liquid crystal polymers easily proceeds.

In the heat-pressing step, a polyimide film, a PTFE film, or a composite sheet including a reinforcing material such as a glass fiber fabric and a heat-resistant resin may be interposed as a release film between a pressing machine used in the heat-pressing step and the liquid crystal polymer fiber mat.

In place of the polyimide film, an additional copper foil may be interposed between the pressing machine and the liquid crystal polymer fiber mat. In this case, it is possible to obtain a liquid crystal polymer film in which copper foils are bonded to both surfaces. The liquid crystal polymer film in which the copper foils are bonded to both surfaces can be used as a double-sided copper bonded FCCL.

An outer dimension of the liquid crystal polymer film molded by the heat-pressing step as viewed from the thickness direction, that is, a planar dimension along a film surface is substantially the same as that of the liquid crystal polymer fiber mat before heat-pressing. Then, by heat-pressing, among the fibrous particles of the liquid crystal polymer powder in the liquid crystal polymer fiber mat, the fibrous particles having the longitudinal direction in a direction along the thickness direction of the liquid crystal polymer fiber mat is heated while being pushed down in the in-plane direction of the copper foil. Since the liquid crystal polymer constituting the liquid crystal polymer powder has the axial direction of the molecule in the longitudinal direction of the fibrous particles, the axial direction of the molecule of the liquid crystal polymer is also pushed down in the in-plane direction of the copper foil. Thus, except for the molecules constituting the massive particles, the axial direction of each molecule constituting the liquid crystal polymer is oriented along the in-plane direction of the liquid crystal polymer film over the thickness direction of the liquid crystal polymer film. Therefore, in the molded liquid crystal polymer film, the main orientation direction of the molecules of the liquid crystal polymer tends to be along the in-plane direction of the copper foil, that is, the in-plane direction of the liquid crystal polymer film.

This is considered to reduce the in-plane linear expansion coefficient in the liquid crystal polymer film of the present embodiment. A liquid crystal polymer film having a low in-plane linear expansion coefficient has an advantage of excellent dimensional stability.

When the copper foil is bonded to the liquid crystal polymer film, the linear expansion coefficient of the liquid crystal polymer film can be reduced to the same level as the linear expansion coefficient (about 18 to 20 ppm/° C.) of the copper foil. As a result, defects such as warpage due to thermal shrinkage can be suppressed in the liquid crystal polymer film to which the copper foil is bonded.

In addition, the liquid crystal polymer powder in the liquid crystal polymer fiber mat may be bonded to each other while the fibrous particles are entangled with each other. Thus, the liquid crystal polymer in the liquid crystal polymer film has a structure in which molecules are entangled with each other. Since the fibrous particle has a larger surface area than a spherical liquid crystal polymer having the same volume, a bonding area also increases when the liquid crystal polymer powders are bonded to each other by the heat-pressing step. Thus, the liquid crystal polymer film according to the present embodiment is improved in toughness and folding resistance strength. By the heat-pressing step, the thickness of the liquid crystal polymer film is thinner than that of the liquid crystal polymer fiber mat.

A liquid crystal polymer mat obtained by matting a conventional liquid crystal polymer powder containing no fibrous particles as described above does not contain fibrous particles having the axial direction of the molecular axis in the longitudinal direction. Thus, when such a liquid crystal polymer mat is heat-pressed, the axial direction of the molecules constituting the liquid crystal polymer in the liquid crystal polymer film is not pushed down. Thus, when a liquid crystal polymer film is produced using the conventional liquid crystal polymer powder containing no fibrous particles, the main alignment direction of each molecule constituting the liquid crystal polymer is not along the in-plane direction of the liquid crystal polymer film.

When the liquid crystal polymer fiber mat obtained by matting the conventional liquid crystal polymer powder containing no fibrous particles is heat-pressed, the bonding area is extremely small when the liquid crystal polymer powders are bonded to each other. For this reason, when the liquid crystal polymer film produced using the conventional liquid crystal polymer powder containing no fibrous particles is subjected to an external force, stress concentrates on a bonding portion between the liquid crystal polymer powders. Since the bonding area of the bonding portion is small, when the liquid crystal polymer film is subjected to an external force, the liquid crystal polymer film is broken at the bonding portion. As described above, the liquid crystal polymer film produced using the conventional liquid crystal polymer powder containing no fibrous particles has low strength and low toughness and folding resistance strength. The liquid crystal polymer film cannot be used as a substrate for FPC, a diaphragm, or a damping plate.

### (Metal Foil Removing Step: S24)

Finally, the metal foil bonded to the liquid crystal polymer film may be removed by etching or the like as necessary. As a result, a single liquid crystal polymer film to which the metal foil is not bonded is obtained.

According to the method of producing a liquid crystal polymer film of the present embodiment, by producing a liquid crystal polymer film using a liquid crystal polymer powder containing fibrous particles having an average aspect ratio of 10 or more and 500 or less and an average diameter of 2 μm or less, which could not be conventionally realized, a liquid crystal polymer film having excellent folding resistance strength and the like, which can be suitably used as a circuit board, can be obtained.

In the prior art, an LCP film has been produced by a melt extrusion method, a solution casting method, or the like. In the case of the melt extrusion method, it has been necessary to use LCP having a relatively low melting point that can be melted in a production facility. In the case of the solution casting method, it is necessary to use LCP or the like having an amide bond that can be dispersed in a solvent. On the other hand, in the method of producing an LCP film of the present embodiment, since it is not necessary to melt the LCP, the LCP is not limited to the LCP having a low melting point or the LCP dispersible in the solvent as described above, and other LCPs can be used. Therefore, for example, a liquid crystal polymer having a melting point higher than 330° C. can be employed, and a liquid crystal polymer film containing the liquid crystal polymer having a melting point higher than 330° C. and having excellent heat resistance can be produced.

### <Method of Producing Fiber Mat>

As shown in FIG. 14, a method of producing a fiber mat according to the present embodiment includes a dispersion step (S31) and a matting step (S32). The dispersion step (S31) is the same as the dispersion step (S21) in the method of producing a liquid crystal polymer film.

In the matting step (S32), the slurry-like liquid crystal polymer powder is molded into a liquid crystal polymer fiber mat by a papermaking method. In the papermaking method, the dispersing medium used in the dispersion step can be recovered and reused, and a fiber mat can be produced at low cost.

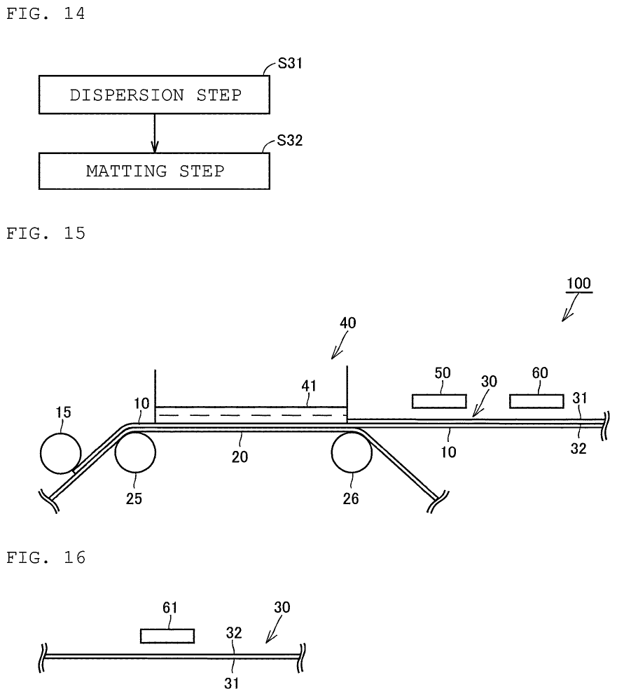

FIG. 15 is a view showing an example of the matting step of matting the liquid crystal polymer powder in a step of producing a fiber mat. Details of the matting step will be described with reference to FIG. 15.

As shown in FIG. 15, a paper machine 100 is used in the matting step. The paper machine 100 includes a supply roller 15 that supplies a microporous sheet 10, a winding roller (not illustrated) that collects the microporous sheet 10, a papermaking wire 20, conveying rollers 25 and 26, a storage portion 40 that stores a dispersing medium 41 in which the liquid crystal polymer powder is dispersed, a heating device 50, and a light irradiation device 60.

The papermaking wire 20, for example, is a papermaking net of about 80 to 100 mesh. That is, the papermaking wire 20 has a pore diameter of about 150 μm to 180 μm. The papermaking wire 20 is conveyed by the conveying rollers 25 and 26 arranged in the conveyance direction. The conveying roller 26 is disposed on the downstream side of the conveying roller 26. The papermaking wire 20 is conveyed by the conveying rollers 25 and 26 so as to pass through the storage portion 40.

The supply roller 15 supplies the microporous sheet 10 onto the papermaking wire 20. The microporous sheet 10 functions as a support that supports the liquid crystal polymer powder. The microporous sheet 10 disposed on the papermaking wire 20 is conveyed by the papermaking wire 20 so as to pass through the storage portion 40. The microporous sheet 10 having passed through the storage portion 40 is peeled off from the papermaking wire 20 and wound up by a winding roller.

The microporous sheet 10 has a mesh finer than that of the papermaking wire 20. The microporous sheet 10 is preferably about 157 mesh or more. That is, the microporous sheet 10 preferably has a pore diameter of about 100 μm or less. Thus, the fine liquid crystal polymer powder dispersed in the dispersing medium can be collected.

More preferably, the microporous sheet 10 preferably has a pore diameter of about 5 μm to 50 μm. When the pore diameter of the microporous sheet 10 is too small, the water-filterability is deteriorated, and the time required for dehydration becomes long. On the other hand, when the pore diameter of the microporous sheet 10 is too large, fine fibers (fine liquid crystal polymer powder) are hardly collected, and the yield becomes poor.

When the microporous sheet 10 having variations in pore diameter is selected, it affects the formation of the fiber mat to be formed, and therefore when high uniformity is required for the fiber mat, a mesh periodically knitted in a mesh shape is preferable. That is, as the microporous sheet 10, it is preferable to use a mesh having a uniform pore diameter and no bias in the location of pores.

As the microporous sheet 10, for example, a woven fabric mesh having a pore diameter of 50 μm or less can be used. As the woven fabric mesh, for example, a woven fabric mesh constituted of synthetic fibers such as polyester can be adopted.

As the microporous sheet 10, for example, a wet nonwoven fabric having a basis weight of 15 g/m² or less may be used. As the wet nonwoven fabric, a wet nonwoven fabric constituted of microfibers can be used. The microfiber is constituted of, for example, a synthetic fiber such as polyester.

The heating device 50 is disposed on the downstream side of the storage portion 40 in the conveyance direction. The heating device 50 heats and dries the liquid crystal polymer powder 30 which is subjected to papermaking on the microporous sheet 10. As a result, a fiber mat is formed on the microporous sheet 10.

The light irradiation device 60 is disposed on the downstream side of the heating device 50 in the conveyance direction. The light irradiation device 60 irradiates the fiber mat formed on the microporous sheet 10 with light. As the light irradiation device 60, for example, a flash lamp can be adopted.

The light irradiation device 60 preferably emits pulsed light. Since the pulsed light is absorbed by the surface (first main surface 31) of the fiber mat, the support (microporous sheet 10) supporting the fiber mat is not deteriorated by light irradiation. Thus, a material having a melting point lower than that of the fiber mat can be used as a support, and the range of selection of the support is widened. Since the fiber mat can be prevented from being fused to the support, the support can be repeatedly used. As the light irradiation device 60, a light irradiation device (PulseForge (registered trademark) 1300 manufactured by NovaCentrix) can be adopted.

The matting step (S32) includes a papermaking step, a peeling step, and a drying step, and may further include a light irradiation step. In the matting step (S32), first, the dispersed liquid crystal polymer powder is subjected to papermaking on the microporous sheet 10 in the papermaking step. Specifically, the microporous sheet 10 supplied onto the papermaking wire 20 is conveyed by the papermaking wire 20 and allowed to pass through the storage portion 40. At this time, the liquid crystal polymer powder dispersed in the dispersing medium 41 stored in the storage portion 40 is subjected to papermaking on the microporous sheet 10.

Subsequently, in the peeling step, the microporous sheet obtained by papermaking the dispersed liquid crystal polymer powder thereon is peeled off from the papermaking wire 20. Specifically, the microporous sheet 10 is wound by a winding roller to convey the microporous sheet 10 in a direction different from the direction of the papermaking wire 20. The papermaking wire 20 may be conveyed in a direction different from the direction of the microporous sheet 10 by the conveying roller 26.

Next, in the drying step, the liquid crystal polymer powder which is subjected to papermaking on the microporous sheet 10 is heated and dried by the heating device 50. As a result, a fiber mat 30 constituted of a liquid crystal polymer is formed on the microporous sheet 10.

Subsequently, in the light irradiation step, the first main surface 31 of the fiber mat 30 located on the side opposite to the side where the microporous sheet 10 is located is irradiated with light. As a result, the liquid crystal polymer powder located on the first main surface 31 side is fused. As a result, the strength of the fiber mat 30 is improved, and the fiber mat 30 can be carried to the next step without being damaged.

In addition, since only the liquid crystal polymer powder located on the surface layer on the first main surface 31 side is fused, the density of the entire fiber mat 30 is low. Accordingly, high air permeability and high collection efficiency can be secured.

The fiber mat 30 after light irradiation is wound by the winding roller in the winding step in a state of being disposed on the microporous sheet 10.

FIG. 16 is a view showing a step of irradiating a second surface of the fiber mat with light. As shown in FIG. 16, the matting step may further include a step of peeling the fiber mat 30 irradiated with light on the first main surface 31 from the microporous sheet 10, and irradiating the second main surface 32 of the fiber mat 30 located on the side opposite to the side where the first main surface 31 is located with light. In this step, the fine fibers located on the second main surface 32 side are fused by light irradiation from the light irradiation device 61. As the light irradiation device 61, a device similar to the light irradiation device 60 described above can be used. At the time of light irradiation, the fiber mat 30 is irradiated while being conveyed.

When the liquid crystal polymer powder is fused on both the first main surface 31 side and the second main surface 32 side, the strength of the fiber mat 30 can be further improved.

When the fiber mat 30 is peeled off from the microporous sheet 10, the liquid crystal polymer powder is fused on the first main surface 31 side, and the fiber mat 30 has sufficient strength, so that the fiber mat 30 can be peeled off without being damaged. The fiber mat 30 thus prepared may be used as it is, or may be subjected to the heat-pressing step S23 of the method of producing a liquid crystal polymer film.

In the present embodiment, the fiber mat 30 is irradiated with light. When the liquid crystal polymer powder contained in the fiber mat contains a zirconium compound, light irradiation efficiency may be increased by the light absorption characteristics by the zirconium compound. When the light irradiation efficiency is increased, the breaking tension of the fiber mat may be improved.

### <<Method of Processing Liquid Crystal Polymer Film and Fiber Mat>>

In the present embodiment, the liquid crystal polymer film and the fiber mat are processed by laser irradiation to form a through-hole or a cut portion. For the laser irradiation, for example, a commercially available laser processing machine using CO₂ or a semiconductor as a laser oscillator can be used. The beam spot diameter of the laser beam can be changed by changing the lens of the laser processing machine. In order to perform fine processing, it is preferable that the beam spot diameter is small.

When the liquid crystal polymer film or the fiber mat contains a zirconium compound, the irradiation efficiency by laser irradiation is improved, and formation of a through-hole is facilitated.

### EXAMPLES

Hereinafter, the present invention will be described in more detail with reference to examples, but the present invention is not limited thereto.

### Example 1

### (Production of Liquid Crystal Polymer Pellet)

In Example 1, first, a uniaxially oriented liquid crystal polymer pellet was produced as the LCP pellet. Specifically, a pellet was prepared by a melt extrusion method under the following conditions.

The liquid crystal polymer raw material used for the production of the LCP pellet had a melting point of 320° C. and a melt viscosity (MV) of 32 Pas. The material of the liquid crystal polymer raw material is a copolymer of HBA (p-hydroxybenzoic acid) and HNA (4-hydroxy2-naphthoic acid). Before the melt-kneading step, a powder of the LCP raw material was dried at 150° C. for 2 hours in order to prevent mixing of moisture.

The melt-kneading step and the extrusion step were performed using a co-rotating twin screw extruder “HK-25D” (manufactured by Parker Corporation). A screw of the extruder has a diameter D of 25 mm and L (length)/D of 41. A nozzle of the extruder is a single-hole nozzle having a diameter of 5 mm.

In the melt-kneading step and the extrusion step, first, a powder or pellet of the LCP raw material was charged from a hopper to supply the LCP raw material to the extruder. The supply amount of the LCP raw material was 2 kg/h. A constant amount of the LCP raw material was supplied using a weight type light weight single shaft feeder “K-CL-SFS-KQx4” (manufactured by Coperion GmbH).

In the co-rotating twin screw extruder described above, the supplied LCP raw material was melt-kneaded by the screw, and a string shape LCP was extruded from the nozzle. The screw rotation speed was 200 rpm, and the melt extrusion temperature (temperature when the molten LCP raw material was extruded from the hole of the nozzle) was 320° C. Here, the extrusion amount (Q) of the string shape material was basically the same as the supply amount of the LCP raw material, and was 2 kg/h.

Next, in the cooling step, the string shape material (strand) obtained in the extrusion step was cooled in water by allowing the string shape material to pass through water while taking up string shape material. The take-up speed (V) of the string shape material was 39.3 m/min. The ratio (V/Q) of the take-up speed (V) to the extrusion amount (Q) was about 19.6. A distance in a horizontal direction at which the string shape material was immersed in water was 105 cm.

Next, in the cutting step, the string shape material after the cooling step was cut to obtain a trapezoidal columnar LCP pellet. As for the size of the trapezoidal column, the upper base of the trapezoid was 2 mm, the lower base was 3 mm, and the height (thickness) was 1 mm, and the length of the trapezoidal column was 4 mm.

### (Production of Liquid Crystal Polymer Powder)

The LCP pellet obtained above was coarsely ground by a cutter mill (MF10, manufactured by IKA). The coarsely ground liquid crystal polymer was passed through a mesh having a diameter of 3 mm provided at a discharge port of the cutter mill to obtain a coarsely ground liquid crystal polymer.

Next, the coarsely ground liquid crystal polymer was finely ground with a liquid nitrogen bead mill (LNM-08 manufactured by AIMEX CORPORATION, vessel capacity: 0.8 L). Specifically, 400 mL of media and 30 g of coarsely ground liquid crystal polymer were put into a vessel, and grinding treatment was performed at a rotation speed of 2000 rpm (disk peripheral speed: 5.2 m/s) for 120 minutes. As the medium, beads made of zirconia (ZrO₂) having a diameter of 5 mm were used. Note that, in the liquid nitrogen bead mill, wet grinding treatment is performed in a state in which the coarsely ground liquid crystal polymer is dispersed in the liquid nitrogen. As described above, the coarsely ground liquid crystal polymer was ground in the liquid nitrogen bead mill to obtain a granular finely ground liquid crystal polymer.

The particle size of the finely ground liquid crystal polymer was measured. The finely ground liquid crystal polymer dispersed in the dispersing medium was subjected to ultrasonic treatment for 10 seconds, and then set in a particle size distribution measuring device (LA-950 manufactured by HORIBA Ltd.) by a laser diffraction scattering method to measure the particle size. As the dispersing medium, ethanol was used.

Next, a dispersion liquid obtained by dispersing the finely ground liquid crystal polymer in ethanol was sieved with a mesh having an opening of 100 μm to remove coarse particles contained in the finely ground liquid crystal polymer, and the finely ground liquid crystal polymer having passed through the mesh was recovered. A yield of the finely ground liquid crystal polymer by the removal of coarse particles was 75% by mass.

Next, the finely ground liquid crystal polymer from which the coarse particles had been removed was dispersed in a 20% by mass ethanol aqueous solution. An ethanol slurry in which the finely ground liquid crystal polymer was dispersed was repeatedly ground five times using a wet high-pressure crushing device under the conditions of a slit chamber nozzle diameter of 0.2 mm and a pressure of 200 MPa to be formed into fibers. As the wet high-pressure crushing device, a high-pressure crushing device (Nanoveta manufactured by Yoshida Kikai Kogyo Co., Ltd.) was used. As a result, a liquid crystal polymer powder dispersed in an ethanol aqueous solution was obtained.

### (Production of Liquid Crystal Polymer Film)

First, the paste of liquid crystal polymer powder was applied onto a copper foil and dried to form a web of liquid crystal polymer (liquid crystal polymer fiber mat) on the copper foil.

Specifically, first, terpineol having a mass 20 times the mass of the dispersed liquid crystal polymer powder was added to the ethanol aqueous solution in which the liquid crystal polymer powder was dispersed. Then, the aqueous solution was heated while being stirred to vaporize and remove water and ethanol. Thus, a liquid crystal polymer powder dispersed in terpineol was obtained. That is, the liquid crystal polymer powder was dispersed in terpineol as a dispersing medium to form a paste.

Next, a paste-like liquid crystal polymer was applied onto a roughened surface of an electrolytic copper foil (FWJ-WS-12 manufactured by Furukawa Electric Co., Ltd.) having a thickness of 12 μm. Then, the electrolytic copper foil applied with the paste-like liquid crystal polymer powder was heated to 130° C. on a hot plate to vaporize terpineol as a dispersing medium, and the paste-like liquid crystal polymer powder on the electrolytic copper foil was dried. In this way, a thin liquid crystal polymer fiber mat was formed on the electrolytic copper foil.

The paste-like liquid crystal polymer powder was further applied onto the thin liquid crystal polymer fiber mat. The applied paste-like liquid crystal polymer powder was dried in the same manner as when the paste-like liquid crystal polymer applied previously was dried. As described above, the application and drying were repeated a plurality of times to form the liquid crystal polymer fiber mat adjusted so that the basis weight was 35 g/m² on the electrolytic copper foil.

Next, the liquid crystal polymer fiber mat formed on the electrolytic copper foil was heat-pressed together with the electrolytic copper foil using a vacuum high-temperature press apparatus (KVHC manufactured by Kitagawa Seiki Co., Ltd.). Specifically, first, a release film was stacked on an opposite side to the electrolytic copper foil side of the liquid crystal polymer fiber mat formed on the electrolytic copper foil. As the release film, a polyimide film (Kapton (registered trademark) 100H manufactured by DU PONT-TORAY CO., LTD.) was used. Then, the liquid crystal polymer fiber mat on which the release film was stacked was set in the vacuum heating press apparatus at room temperature. The temperature of the set liquid crystal polymer fiber mat was raised to 305° C. at a rate of 7ºC/min while the liquid crystal polymer fiber mat was pressed together with the release film and the electrolytic copper foil at a press pressure of 0.2 MPa. After the temperature reached 305° C., the liquid crystal polymer film was pressed together with the release film and the electrolytic copper foil at a press pressure of 6 Mpa for 5 minutes while the temperature was maintained at 305° C. A press size (length of one side of a square liquid crystal polymer fiber mat) was 170 mm. After completion of the heat-pressing, the release film was removed to obtain a liquid crystal polymer film formed on the electrolytic copper foil.

Finally, the electrolytic copper foil bonded to the liquid crystal polymer film was removed by etching using an aqueous solution of ferric chloride. Thus, a liquid crystal polymer film was obtained. The thickness of the liquid crystal polymer film was 25 μm.

### Example 2

In Example 2, the supply amount of the LCP raw material (the extrusion amount of the string shape material) was 3 kg/h, and the take-up speed was 42.3 m/min. In the other respects, an LCP pellet and an LCP powder were produced similarly to Example 1 to obtain an LCP film.

### Example 3

In Example 3, an LCP raw material (copolymer of HBA (p-hydroxybenzoic acid) and HNA (4-hydroxy2-naphthoic acid)) having MV of 33 (melting point: 320° C.) was used. In addition, the supply amount of the LCP raw material (the extrusion amount of the string shape material) was 4 kg/h, and the take-up speed was 26.3 m/min. In the other respects, an LCP pellet and an LCP powder were produced similarly to Example 2 to obtain an LCP film.

### Example 4

In Example 4, an LCP raw material (copolymer of HBA (p-hydroxybenzoic acid) and HNA (4-hydroxy2-naphthoic acid)) having MV of 32 (melting point: 320° C.) was used. The take-up speed was 20.3 m/min. In the other respects, an LCP pellet and an LCP powder were produced similarly to Example 3 to obtain an LCP film.

### Comparative Example 1

In Comparative Example 1, the supply amount of the LCP raw material (the extrusion amount of the string shape material) was 8 kg/h. In the other respects, an LCP pellet and an LCP powder were produced similarly to Example 2 to obtain an LCP film. The shape of the LCP pellet of Comparative Example 1 was a shape close to an elliptic cylinder having a major axis of 4 mm, a minor axis of 1 mm, and a length of 4 mm.

### Comparative Example 2

In Comparative Example 2, the supply amount of the LCP raw material (the extrusion amount of the string shape material) was 8 kg/h. In the other respects, an LCP pellet and an LCP powder were produced similarly to Example 3 to obtain an LCP film.

### [Observation on Liquid Crystal Polymer Pellet]

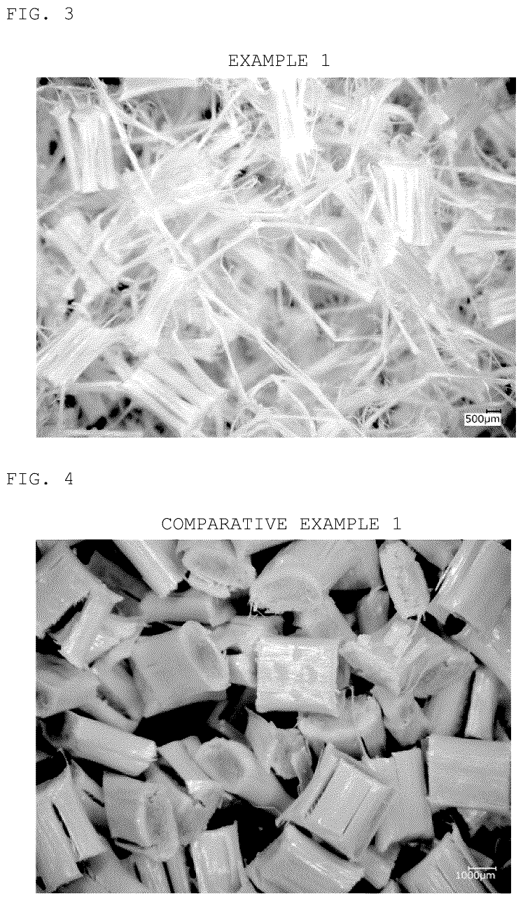

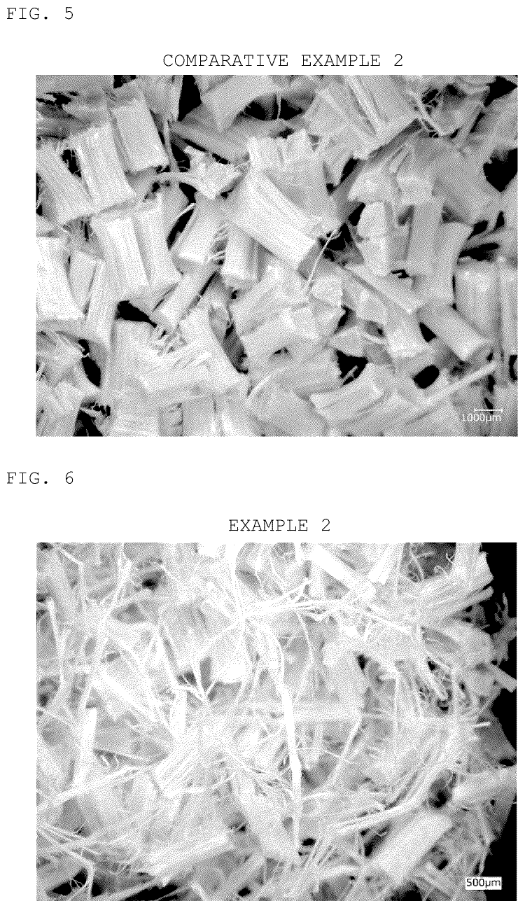

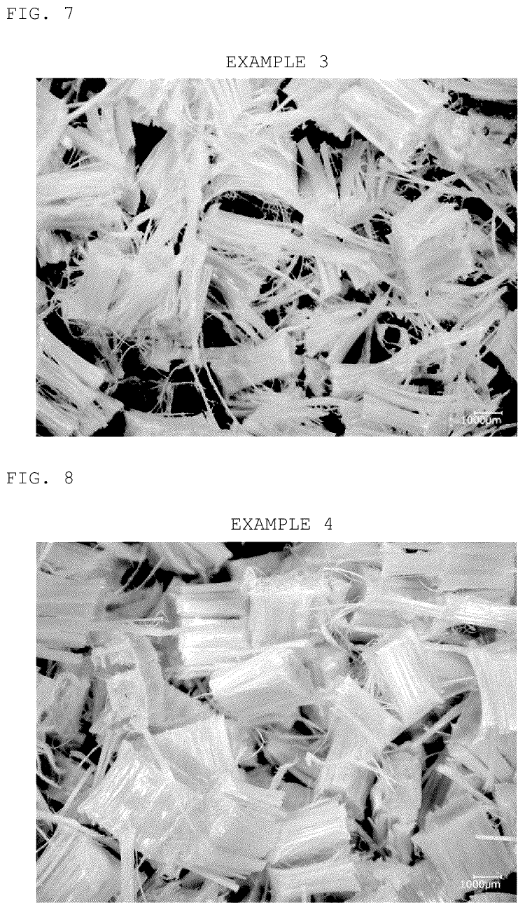

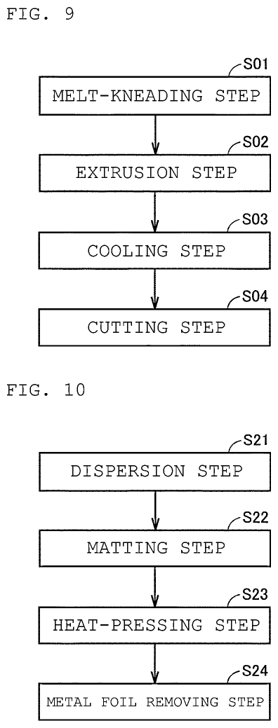

The liquid crystal polymer pellets in Example 1, Comparative Example 1, Comparative Example 2, Example 2, Example 3, and Example 4 were observed. FIGS. 3 to 8 are photographs of liquid crystal polymer pellets taken in Example 1, Comparative Example 1, Comparative Example 2, Example 2, Example 3, and Example 4, respectively. The photographing was performed at a magnification of 20 times using a digital microscope (VHX-5000) manufactured by Keyence Corporation. From the photographs of FIGS. 3 to 8, it can be seen that in the LCP pellets of Examples, fibrous branch portions such as burrs and fluffs are large as compared with the LCP pellets of Comparative Examples.

### [Measurement of Orientation Degree of Liquid Crystal Polymer Pellet]

For the liquid crystal polymer pellets according to each of Examples and Comparative Examples, the degree of orientation was measured by wide-angle X-ray scattering (WAXS).

Specifically, the WAXS analysis was performed using the wide-angle measurement mode of a small-angle X-ray scattering analyzer (“NANOPIX” manufactured by Rigaku Corporation). The distance between the sample of the liquid crystal polymer pellet and the detector was set to 80 mm, and Si was used for calibration of the distance. The sample was irradiated with X-rays and the scattered X-rays were detected by the detector in a vacuum environment. Between the sample and the detector, a beam stopper was placed, which blocked some of the scattered X-rays from reaching the detector. The degree of orientation was calculated from an annular integration at the strongest peak of scattering intensity of the scattered X-rays.

### [Measurement of Solidified Bulk Density of Liquid Crystal Polymer Pellet]

The solidified bulk density of the liquid crystal polymer pellets according to each of Examples and Comparative Examples was measured.

Specifically, first, the LCP pellet was filled up to a scale of 100 mL in a measuring cylinder (maximum scale: 100 mL), and the weight of the filled LCP pellet was measured. Thereafter, tapping (vertical vibration of the measuring cylinder) was performed 10 times, and the volume of the LCP pellet after tapping was confirmed on the scale of the measuring cylinder. The solidified bulk density was calculated from the following formula.

$$Solidifed bulk density ( g / {cm}^{3} ) = [ weight ( g ) of filled LCP pellet ] / [ volume ( {cm}^{3} ) of LCP pellet after tapping ]$$

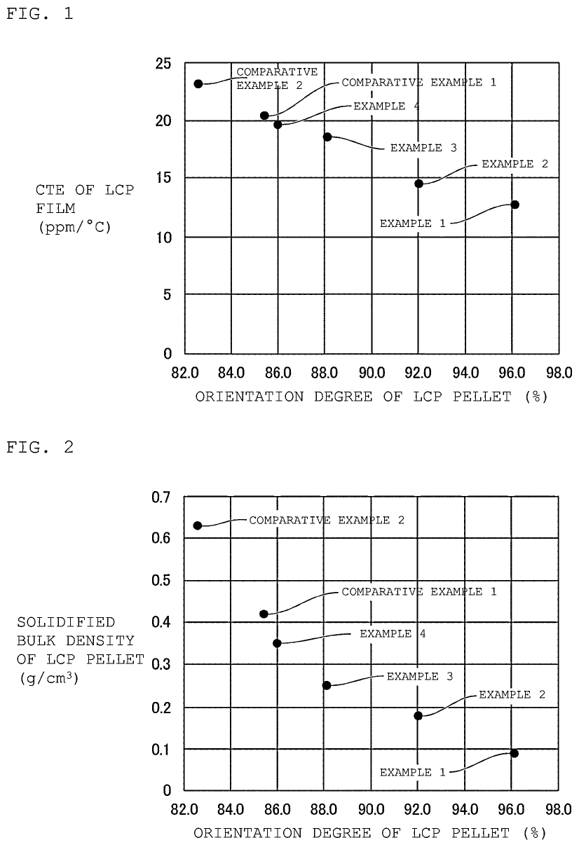

The measurement results of the solidified bulk density of the liquid crystal polymer pellet are shown in Table 1 and FIG. 2.

### [Measurement of Linear Expansion Coefficient]

The in-plane linear expansion coefficients of the liquid crystal polymer films according to each of Examples and Comparative Examples were measured. Specifically, the in-plane (XY direction) linear expansion coefficient of the liquid crystal polymer film was measured according to JIS K 7197 by a TMA (thermomechanical analysis) method. Conditions of the TMA were as follows: a temperature was raised from room temperature to 150° C. at 10° C./min under a nitrogen atmosphere, a load was 10 g, and a sample shape was a strip shape (5 mm×15 mm).

The measurement results of the linear expansion coefficient (CTE) of the liquid crystal polymer film are shown in Table 1 and FIG. 1.

TABLE 1

| | LCP pellet | | | | | | | LCP powder | | |
|---|---|---|---|---|---|---|---|---|---|---|
| | | Extrusion | Take-up | | Melt- | | Solidified | Average | Average | |
| | | amount | speed | | extrusion | Orientation | bulk | fiber | fiber | LCP film |
| | MV | Q | V | | temperature | degree | density | length | thickness | CTE |
| | (Pa · s) | (kg/h) | (m/min) | V/Q | (° C.) | (%) | (g/cm³) | (μm) | (μm) | (ppm/° C.) |
| Example 1 | 32 | 2 | 39.3 | 19.6 | 320 | 96.1 | 0.09 | 18.0 | 0.9 | 12.8 |
| Example 2 | 32 | 3 | 42.3 | 14.1 | 320 | 92.0 | 0.18 | 17.0 | 1.1 | 14.6 |
| Example 3 | 33 | 4 | 26.3 | 6.6 | 320 | 88.1 | 0.25 | 16.5 | 1.3 | 18.6 |
| Example 4 | 32 | 4 | 20.3 | 5.0 | 320 | 86.0 | 0.35 | 16.0 | 1.5 | 19.7 |
| Comparative | 33 | 8 | 26.3 | 3.3 | 310 | 82.6 | 0.63 | 15.0 | 2.0 | 23.2 |
| Example 1 | | | | | | | | | | |
| Comparative | 33 | 4 | 26.3 | 6.6 | 310 | 85.4 | 0.42 | 15.5 | 1.7 | 20.4 |
| Example 2 | | | | | | | | | | |

From the results shown in Table 1 and FIG. 1, it is found that in Examples in which the ratio (V/Q) of the take-up speed (V) to the extrusion amount (Q) of the string shape material is 5 or more in the process of producing the LCP pellet, the LCP pellet having an orientation degree of 86% or more can be obtained. On the other hand, in Comparative Examples in which V/Q was less than 5, the degree of orientation of the LCP pellet was less than 86%. This is considered to be because when V/Q is 5 or more, a stretch ratio is increased, and the liquid crystal molecules are easily aligned in the same direction.

It is apparent that the liquid crystal polymer films of Examples 1 to 4 produced using the liquid crystal polymer pellet having an orientation degree of 86% or more have a CTE of 20 ppm/° C. or less, and the CTE is smaller than those of the liquid crystal polymer films of Comparative Examples 1 and 2 produced using the liquid crystal polymer pellet having an orientation degree of less than 86%.

When the degree of orientation of the LCP is increased at the stage of producing the LCP pellet, the finely ground LCP refined by grinding the LCP pellet becomes particles having a highly oriented state derived from the pellet inside. By treating the particles with a wet high-pressure crushing device, an LCP powder containing the fibrous particles of the liquid crystal polymer maintaining the highly oriented state is obtained.

In general, in the liquid crystal polymer, the connection of LCPs in a direction perpendicular to alignment of molecular chains is more likely to be broken than the connection of LCPs in the molecular chain direction. Thus, the fibrous particles contained in the prepared LCP powder are likely to have a fibrous shape that is long in the orientation direction and short in a direction perpendicular to the orientation.

The liquid crystal polymer has a negative thermal expansion coefficient in the direction in which the molecules are aligned. Thus, when an LCP film is produced using such an LCP powder, an LCP film having a small in-plane (planar direction) linear expansion coefficient (thermal expansion coefficient) can be obtained.

In addition, from the results shown in Table 1 and FIG. 2, it is found that the solidified bulk density of the liquid crystal polymer pellet decreases as the degree of orientation of the liquid crystal polymer pellet increases. This is considered to be because as the degree of orientation of the liquid crystal polymer pellet increases, the molecules are aligned and become more fibrous, so that a void becomes large due to fibrous branch portions such as burrs and fluffs generated during cutting.

It is considered that by producing a liquid crystal polymer film using a liquid crystal polymer pellet having a high degree of orientation and a high bulk density, a liquid crystal polymer film including fine fibers (fibrous particles) having a high degree of orientation is formed, and the in-plane CTE of the liquid crystal polymer film is reduced.

### <Reference Test 1>

An LCP powder and an LCP film were produced similarly to Example 2 except that only the take-up speed was changed to 4.6 m/min and 46.3 m/min. For these, the solidified bulk density of the LCP pellet, the degree of orientation of the LCP pellet, and the CTE of the LCP film were measured similarly to above.

FIG. 12 graphically shows a relationship between the take-up speed (m/min) and each of the solidified bulk density (g/cm³) of the LCP pellet, the degree of orientation (%) of the LCP pellet, and the CTE (ppm/° C.) of the LCP film when the take-up speed (draw ratio) is changed in this way.

From the results shown in FIG. 12, it can be seen that when the draw ratio (take-up speed) is increased, the degree of orientation of the LCP pellet increases, and the solidified bulk density of the LCP pellet decreases. In addition, it can be seen that this reduces the CTE of the LCP film.

When the draw ratio is excessively lowered, the supply amount of the LCP raw material exceeds a recovery amount (take-up amount) of the string shape material, and the pellet may not be produced. When the draw ratio is excessively increased, there is a possibility that the string shape material is cut by taking up the string shape material (strand), and the pellet may not be produced.

### <Reference Test 2>

An LCP powder and an LCP film were produced similarly to Example 2 except that the melt extrusion temperature was changed to 310° C., 320° C., and 330° C. For these, the solidified bulk density of the LCP pellet, the degree of orientation of the LCP pellet, and the CTE of the LCP film were measured similarly to above.

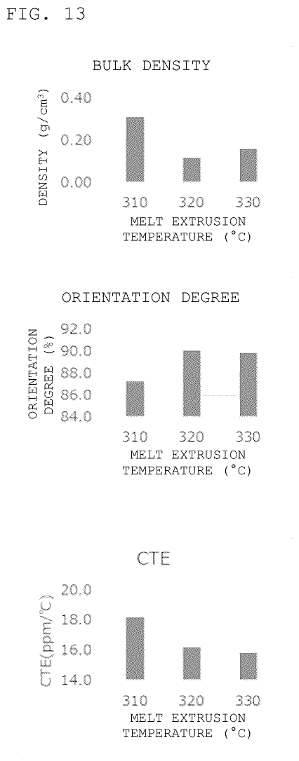

FIG. 13 graphically shows a relationship between the melt extrusion temperature (° C.) and each of the solidified bulk density (g/cm³) of the LCP pellet, the degree of orientation (%) of the LCP pellet, and the CTE (ppm/° C.) of the LCP film when the melt extrusion temperature is changed in this way.

From the results shown in FIG. 13, it can be seen that when the melt extrusion temperature is equal to or higher than the melting point of the LCP raw material, the degree of orientation of the LCP pellet increases, and the solidified bulk density of the LCP pellet decreases. In addition, it can be seen that this reduces the CTE of the LCP film.

This is considered to be because when the melt extrusion temperature is equal to or higher than the melting point of the LCP raw material, fluidity of the LCP increases, and the molecules are easily aligned when the LCP is injected from the hole of the nozzle of the extruder.

If the melt extrusion temperature is excessively increased, the temperature exceeds the decomposition temperature of the resin, which makes it difficult to produce the LCP pellet.

### Example 5

A liquid crystal polymer film of Example 5 was produced using the same raw materials as in Example 4. Example 4 is different from Example 4 only in that a pre-pressing step was performed as a step before heat-pressing the liquid crystal polymer fiber mat formed on the electrolytic copper foil together with the electrolytic copper foil using a vacuum high-temperature press apparatus. In the pre-pressing step, first, a step of pressing at normal temperature (7 MPa, 10 sec) and then pressing at 200° C. (7 MPa, 10 sec) was performed. Thereafter, the same treatment as in Example 4, specifically, a heat treatment was performed using a vacuum high-temperature press apparatus (KVHC manufactured by Kitagawa Seiki Co., Ltd.).

### (Evaluation)

For the fiber mats of Examples 4 and 5, the density was measured by the following method. The linear expansion coefficient (CTE) of the liquid crystal polymer film of Example 5 was measured by the same method as that used for the liquid crystal polymer film of Example 4 above. The measurement results are shown in Table 2.

### (Density Measurement of Fiber Mat)

The density of the fiber mat was calculated by measuring the weight and thickness of the liquid crystal polymer fiber mat formed on the electrolytic copper foil. Specifically, the weight of the fiber mat of the liquid crystal polymer was calculated by subtracting the weight of the electrolytic copper foil from the measured weight. The thickness was measured using a microgauge.

TABLE 2

| | Density | CTE |
|---|---|---|
| | (g/cm³) | (ppm/° C.) |
| Example 4 | 0.2 | 19.7 |
| Example 5 | 1.2 | 15.2 |

From the results shown in Table 2, it can be seen that the linear expansion coefficient (CTE) of the liquid crystal polymer film decreases as the density of the fiber mat increases by performing the pre-pressing. By the pre-pressing, among the fibrous particles of the liquid crystal polymer powder in the fiber mat, the fibrous particles having the longitudinal direction in a direction along the thickness direction of the liquid crystal polymer fiber mat are pushed down in the in-plane direction of the copper foil. Thus, except for the molecules constituting the massive particles, the axial direction of each molecule constituting the liquid crystal polymer is oriented along the in-plane direction of the liquid crystal polymer film over the thickness direction of the liquid crystal polymer film. Therefore, in the molded liquid crystal polymer film, the main orientation direction of the molecules of the liquid crystal polymer tends to be along the in-plane direction of the copper foil, that is, the in-plane direction of the liquid crystal polymer film. As a result, the CTE of the liquid crystal polymer film of the present embodiment is reduced, and defects such as warpage due to thermal shrinkage can be suppressed in the liquid crystal polymer film to which the copper foil is bonded.

### Example 6 and Comparative Example 2

### (Production of Fiber Mat of Example 6 and Comparative Example 2)

Using the liquid crystal polymer powder of Example 4 (melting point: 320° C.), water and ethanol were added in required amounts to prepare 2.2 g of the liquid crystal polymer powder with respect to 30 L of a 50 wt % ethanol aqueous solution, and the slurry-like liquid crystal polymer powder was molded into a fiber mat by a papermaking method. The liquid crystal polymer powder dispersed in a dispersing medium was subjected to papermaking on a microporous sheet of polyester mesh having a pore diameter of 11 μm using a square sheet machine 2555 manufactured by Kumagai Riki Kogyo Co., Ltd. as a paper machine. Subsequently, the fiber mat of Example 6 was molded on the microporous sheet by heating and drying at a temperature of 100° C. using a hot air dryer. The basis weight of the fiber mat was about 35 g/m².

The obtained fiber mat was peeled off from the microporous sheet, and heat-treated at temperatures of 280° C., 320° C., and 360° C. for 1 hour in a Ne atmosphere. As a heating furnace, an inert oven was used.

Using the liquid crystal polymer powder (melting point: 320° C.) of Comparative Example 1, a fiber mat of Comparative Example 2 was produced similarly to the fiber mat of Example 6, and heat-treated at temperatures of 280° C., 320° C., and 360° C. similarly to the fiber mat of Example 6. The breaking tension of the fiber mats of Example 6 and Comparative Example 2 was measured by the following method. The measurement results are shown in Table 3.

### (Measurement of Breaking Tension of Fiber Mat)

The breaking tension was measured for the fiber mats of Example 6 and Comparative Example 2 heat-treated at each temperature. The fiber mat after heat treatment was processed into a width of 20 mm/a length of 100 mm, and the breaking tension was measured using an autograph (AG-XDplus manufactured by Shimadzu Corporation). The measurement was performed at an initial length of 50 mm under the measurement conditions of a take-up speed of 0.33 mm/sec and a mode of pulling.

TABLE 3

| | Heat treatment | Breaking tension |
|---|---|---|
| | temperature (° C.) | (N/20 mm) |
| Example 6 | 280 | 2.2 |
| | 320 | 5.6 |
| | 360 | 8.3 |
| Comparative | 280 | 0.9 |
| Example 2 | 320 | 4.7 |
| | 360 | 8.2 |

From the results shown in Table 3, it was found that in Example 6, a breaking tension of 1.0 N/20 mm or more was obtained when the heat treatment temperature was 280° C., which was equal to or lower than the melting point.

### Examples 7 and 8

### (Production of Fiber Mat of Examples 7 and 8)

When the content of zirconia relative to the total amount of the liquid crystal polymer powder was W (% by weight), the content W of zirconia in the liquid crystal polymer powder of Example 4 was 0.0219% by weight. The content W of zirconia was calculated by the following method. When the liquid crystal polymer powder of Example 4 was subjected to a treatment for removing zirconia by the following method, the content W of zirconia calculated by the following method was 0.0005% by weight.

Fiber mats of Example 7 (produced using liquid crystal polymer powder without zirconia removal treatment) and Example 8 (produced using liquid crystal polymer powder with zirconia removal treatment) were produced using the liquid crystal polymer powder of Example 4 (without zirconia removal treatment, with zirconia removal treatment) similarly to Example 6. A light irradiation treatment was performed on the entire surface of the fiber mat at a table height of 10 mm for 3.5 msec using a light irradiation device (PulseForge (registered trademark) 1300 manufactured by NovaCentrix) at set voltages of 230 V, 250 V, and 270 V in place of the heat treatment of Example 6.

### (Method of Measuring Residual Amount of Zirconia)

In 500 mL of 1 mol % aqua regia, 40 g of liquid crystal polymer powder to be measured is dispersed, and the dispersion is allowed to stand for 10 minutes. The powder and the solution are separated by suction filtration. Using the filtered solution, measurement was performed with an ICP emission spectrometer (ICPS-8100, manufactured by Shimadzu Corporation), and it was confirmed whether detection could be performed at a detection limit or more. A standard solution for a calibration curve was adjusted using ICP standard 1000 mg/LCeriptur (manufactured by Merck KGAA). As the standard solutions for calibration curves, 0, 0.25, 0.50, 1.0, and 2.0 [mg/L] were prepared. Measurement conditions by the ICP emission spectrometer included a twin sequential system, a high frequency output of 1.2 kW, a plasma gas flow rate of 14 L/min, an auxiliary gas flow rate of 1.2 L/min, a carrier gas flow rate of 0.7 L/min, a nebulizer coaxial type, and the measurement direction: lateral direction. The detection limit was 0.02 μg/L or less. The content of zirconium per weight of the liquid crystal polymer powder was calculated from the concentration of the ICP solution. The Zr amount (molecular weight: 91) was converted as a ZrO₂ (zirconia) amount (molecular weight: 123) using the following calculation formula.

$$W ( \% by weight ) = ( zirconium ion concentration ( g / L ) of the measured solution ) \times ( 123 \div 91 ) \times 0.5 L \div 40 g \times 100$$

### (Method of Removing Zirconium)

In 500 mL of 1 mol % aqua regia, 40 g of the prepared liquid crystal polymer powder is dispersed, and the dispersion is allowed to stand for 10 minutes. The powder and the solution are separated by suction filtration, and only the powder is dispersed in 500 mL of pure water. The dispersed powder is separated again by suction filtration. This was repeated three times, and the resultant product was heated on a hot plate to 100° C. to evaporate moisture, thereby producing a liquid crystal polymer powder from which zirconia was removed.

### (Evaluation)

### (Measurement of Breaking Tension)

For the fiber mats of Examples 7 and 8 after the light irradiation treatment, the breaking tension was measured by the above method. The measurement results are shown in Table 4.

TABLE 4

| | Zirconia | Zirconia | Light irradiation | Breaking |
|---|---|---|---|---|
| | removal | content | treatment setting | tension |
| | treatment | (wt %) | voltage (V) | (cN/20 mm) |
| Example 7 | Absence | 0.0219 | 230 | 6 |
| | Absence | 0.0219 | 250 | 14 |
| | Absence | 0.0219 | 270 | 24 |
| Example 8 | Presence | 0.0005 | 230 | 4 |
| | Presence | 0.0005 | 250 | 11 |
| | Presence | 0.0005 | 270 | 14 |

From the results shown in Table 4, it was found that in Example 7, a fiber mat having a high breaking tension was obtained as compared with Example 8.

### (Laser Processability)

The fiber mats of Examples 7 and 8 after light irradiation (those having a light irradiation treatment setting voltage of 230 V) were subjected to laser processing by performing laser irradiation under the following conditions. A KrF excimer laser having a wavelength of 248 nm was generated by COMPexPro series (manufactured by Coherent Inc.), and the generated laser was condensed in a 1 mm square region by a reflection lens and a condenser lens. The produced film was placed at a focal length for condensing light, and the energy of the laser was set so that the energy per irradiation (pulse) was 150 mJ/mm². Then, the energy corresponding to seven irradiations (pulses) was applied. By such laser processing, the fiber mat of Example 7 had a through-hole, and the fiber mat of Example 8 could be cut although the through-hole was not formed. From the above results, it was found that the laser processing could be performed more efficiently in Example 7 in which the removal treatment of zirconia was not performed.

In the description of the above embodiment, combinable configurations may be combined with each other.

The embodiments and examples disclosed herein are all to be considered by way of examples in all respects, but not limiting. The scope of the present invention is specified by the claims, but not the above description, and intended to encompass all modifications within the spirit and scope equivalent to the claims.
<1> A liquid crystal polymer pellet including a liquid crystal polymer and used as a material of a liquid crystal polymer film, the liquid crystal polymer having a degree of orientation measured by a wide-angle X-ray scattering being 86% or more.
<2> The liquid crystal polymer pellet according to <1>, in which a solidified bulk density of the liquid crystal polymer pellet is less than 0.35 g/cm³.
<3> The liquid crystal polymer pellet according to <1> or <2>, wherein the liquid crystal polymer pellet has a fibrous branch portion.
<4> A method of producing a liquid crystal polymer pellet, the method including: kneading a liquid crystal polymer raw material while heating and melting the liquid crystal polymer raw material; extruding the liquid crystal polymer raw material after the kneading and melting into a string shape material; cooling a string shape material obtained in the extrusion step in water while taking up the string shape material; and a cutting step of cutting the string shape material after the cooling, in which a ratio of a take-up speed (m/min) of the string shape material during the cooling to an extrusion amount (kg/h) of the string shape material during the extruding is 5 to 20, and a melt extrusion temperature during the extruding is equal to or higher than a melting point of the liquid crystal polymer raw material.
<5> A liquid crystal polymer pellet obtained by the production method according to <4>.
<6> A method of producing a liquid crystal polymer powder, the method including: grinding the liquid crystal polymer pellet according to any one of <1> to <3> and <5> in a state of being dispersed in liquid nitrogen to obtain a granular finely ground liquid crystal polymer; and crushing the finely ground liquid crystal polymer by a wet high-pressure crushing device to obtain a liquid crystal polymer powder.
<7> The method of producing a liquid crystal polymer powder according to <6>, in which the liquid crystal polymer pellet dispersed in the liquid nitrogen is ground using a medium.
<8> A liquid crystal polymer powder obtained by the production method according to <6> or <7>.
<9> The liquid crystal polymer powder according to <8>, in which when a fiber mat is formed using the liquid crystal polymer powder, and heat treatment is performed at a temperature equal to or lower than the melting point of the liquid crystal polymer powder, the fiber mat has a breaking tension of 1.0 N/20 mm or more.
<10> The liquid crystal polymer powder according to <8> or <9>, further including a zirconium compound.
<11> The liquid crystal polymer powder according to <10>, in which the zirconium compound is contained in an amount of 0.001% by weight to 0.1% by weight with respect to a total amount of the liquid crystal polymer powder.
<12> A liquid crystal polymer film including a liquid crystal polymer, in which an in-plane linear expansion coefficient is 20 ppm/° C. or less.
<13> A fiber mat including a liquid crystal polymer powder, in which a breaking tension of the fiber mat increases by heat treatment at a temperature equal to or lower than a melting point.
<14> The fiber mat according to <13>, in which a density of the fiber mat is 0.1 to 1.5 g/cm³.
<15> A method of producing a liquid crystal polymer film, the method including: dispersing the liquid crystal polymer powder according to any one of <8> to <11> in a dispersing medium to form the liquid crystal polymer powder into a liquid crystal polymer powder paste or slurry; drying the liquid crystal polymer powder paste or slurry to form a liquid crystal polymer fiber mat; and heat-pressing the liquid crystal polymer fiber mat to obtain a liquid crystal polymer film.
<16> The method of producing a polymer film according to <15>, further including applying the liquid crystal polymer powder paste or slurry to a copper foil.
<17> The method of producing a liquid crystal polymer film according to <16>, wherein the liquid crystal polymer fiber mat is heat-pressed together with the copper foil.
<18> The method of producing a liquid crystal polymer film according to any one of <15> to <17>, further including performing pre-pressing at a temperature of 220° C. or lower before the heat-pressing.
<19> The method of producing a liquid crystal polymer film according to any one of <15> to <18>, wherein the liquid crystal polymer powder paste or slurry is formed into the liquid crystal polymer fiber mat by a papermaking method.
<20> A liquid crystal polymer film obtained by the production method according to any one of <15> to <19>.

### DESCRIPTION OF REFERENCE SYMBOLS

10: Microporous sheet
15: Supply roller
20: Papermaking wire
25, 26: Conveying roller
30: Fiber mat
31: First main surface
32: Second main surface
40: Storage portion
41: Dispersing medium
50: Heating device
60: Light irradiation device
100: Paper machine

1. A liquid crystal polymer pellet comprising:
a liquid crystal polymer having a degree of orientation measured by a wide-angle X-ray scattering of 86% or more.

2. The liquid crystal polymer pellet according to claim 1, wherein a solidified bulk density of the liquid crystal polymer pellet is 0.35 g/cm³ or less.

3. The liquid crystal polymer pellet according to claim 2, wherein the solidified bulk density is 0.09 to 0.35 g/cm³.

4. The liquid crystal polymer pellet according to claim 1, wherein the liquid crystal polymer pellet has a fibrous branch portion.

5. The liquid crystal polymer pellet according to claim 1, wherein the liquid crystal polymer has a melt viscosity of 15 to 79 Pa·s.

6. A method of producing a liquid crystal polymer pellet, the method comprising:
kneading a liquid crystal polymer raw material while heating and melting the liquid crystal polymer raw material;
extruding the liquid crystal polymer raw material after the kneading and melting into a string shape material;
cooling the string shape material in water while taking up the string shape material; and
cutting the string shape material after the cooling,
wherein a ratio of a take-up speed (m/min) of the string shape material during the cooling to an extrusion amount (kg/h) of the string shape material during the extruding is 5 to 20, and
a melt extrusion temperature during the extruding is equal to or higher than a melting point of the liquid crystal polymer raw material.

7. A method of producing a liquid crystal polymer powder, the method comprising:
grinding the liquid crystal polymer pellet according to claim 1 in a state of being dispersed in liquid nitrogen to obtain a granular finely ground liquid crystal polymer; and
crushing the finely ground liquid crystal polymer by a wet high-pressure crushing device to obtain a liquid crystal polymer powder.

8. The method of producing a liquid crystal polymer powder according to claim 7, wherein the liquid crystal polymer pellet dispersed in the liquid nitrogen is ground using a medium.

9. A method of forming a fiber mat, the method comprising:
forming a fiber mat using the liquid crystal polymer powder produced according to claim 7; and
heat treating the fiber mat at a temperature equal to or lower than a melting point of the liquid crystal polymer powder so that the fiber mat has a breaking tension of 1.0 N/20 mm or more.

10. A liquid crystal polymer powder comprising:
fibrous particles comprising a liquid crystal polymer having a degree of orientation measured by a wide-angle X-ray scattering of 86% or more.

11. The liquid crystal polymer powder according to claim 10, further comprising a zirconium compound.

12. The liquid crystal polymer powder according to claim 11, wherein the zirconium compound is contained in an amount of 0.001% by weight to 0.1% by weight with respect to a total amount of the liquid crystal polymer powder.

13. A liquid crystal polymer film comprising:
a liquid crystal polymer having a degree of orientation measured by a wide-angle X-ray scattering of 86% or more,
wherein an in-plane linear expansion coefficient of the liquid crystal polymer film is 20 ppm/° C. or less.

14. A fiber mat including a liquid crystal polymer powder, wherein the fiber mat is constructed such that a breaking tension of the fiber mat increases by heat treatment at a temperature equal to or lower than a melting point of the liquid crystal polymer powder.

15. The fiber mat according to claim 14, wherein a density of the fiber mat is 0.1 to 1.5 g/cm³.

16. A method of producing a liquid crystal polymer film, the method comprising:
dispersing the liquid crystal polymer powder according to claim 10 in a dispersing medium to form a liquid crystal polymer powder paste or slurry;
drying the liquid crystal polymer powder paste or slurry to form a liquid crystal polymer fiber mat; and
heat-pressing the liquid crystal polymer fiber mat to obtain a liquid crystal polymer film.

17. The method of producing a polymer film according to claim 16, further comprising applying the liquid crystal polymer powder paste or slurry to a copper foil.

18. The method of producing a liquid crystal polymer film according to claim 17, wherein the liquid crystal polymer fiber mat is heat-pressed together with the copper foil.

19. The method of producing a liquid crystal polymer film according to claim 16, further comprising performing pre-pressing at a temperature of 220° C. or lower before the heat-pressing.

20. The method of producing a liquid crystal polymer film according to claim 16, wherein the liquid crystal polymer powder paste or slurry is formed into the liquid crystal polymer fiber mat by a papermaking method.
